(19) United States
(12) Patent Application Publication
(10) Pub. No.: US 2004/0146052 A1
(43) Pub. Date: Jul. 29, 2004

(54) Apparatus and method for address filtering in a multi-host network interface

(76) Inventor: Tanli Chang, Mountain View, CA (US)

Correspondence Address: PARK, VAUGHAN & FLEMING LLP, 702 MARSHALL STREET, SUITE 310, REDWOOD CITY, CA, 94063, US

(21) Appl. No.: 10/352,506

(22) Filed: Jan. 27, 2003

(51) Int. Cl. H04L 12/56

(52) U.S. Cl. 370/392

(57) ABSTRACT

An apparatus and method for facilitating the transmission of a communication (e.g., packet, cell, frame) received from a first network to one of multiple hosts in a second network. A network interface device compares a first portion of a destination address of the communication to a first host address portion common to each host address. If they match, a second portion of the destination address is used to identify a communication connection (e.g., queue pair, virtual circuit) between the network interface device and the corresponding host. The second portion of the destination address corresponds to a second host address portion unique to each host. The device may include a mask for facilitating comparison of the appropriate portion of the destination address to the common host address portion.

### BACKGROUND

This invention relates to the field of computer systems. More particularly, an apparatus and methods are provided for filtering communications received at a multi-host network interface device, such as a NIC (Network Interface Card).

Traditional network interface cards were configured to interface a single computing device to a network. Because they served only a single host, such NICs only needed to screen incoming communications (e.g., packets, frames, cells) for a single MAC (Medium Access Control) address.

However, as computing and communication devices have evolved, the number of hosts served by a single NIC has increased. Now, a NIC may have to screen incoming communications for multiple MAC addresses associated with multiple hosts. As the number of hosts grows, and the rate of network communications increases ever higher, there is a danger that a multi-host NIC may be unable to screen all incoming communications for addresses of all its hosts. Not only must the multi-host NIC recognize an incoming communication as being directed to one of its hosts, but it must direct the communication to the proper host over the appropriate connection. This becomes more difficult if the NIC serves as an interface between different networks (e.g., as part of a bridge, router or switch).

### SUMMARY

In one embodiment of the invention, an apparatus and methods are provided for facilitating the rapid filtering or screening of communications at a multi-host network interface device (e.g., a NIC). In this embodiment, the NIC may identify that a particular communication is directed to one of its hosts based on just a first portion of a destination address of the communication. The NIC may then use a second portion of the destination address as a lookup into a table identifying communication connections for each host.

In one method according to this embodiment, a communication is received at a network interface device. A first portion of a destination address of the communication is compared to a first address portion common to addresses of multiple hosts coupled to the network interface device. The communication is then forwarded to a host identified by a second portion of the destination address. In this method, the first portion of the destination address is distinct from the second portion of the destination address.

### DESCRIPTION OF THE FIGURES

FIG. 1 is a block diagram depicting a network environment including a multi-host NIC, in accordance with an embodiment of the present invention.

FIG. 2 is a block diagram of a multi-host NIC according to one embodiment of the invention.

FIG. 3 is a flowchart illustrating one method of filtering and redirecting communications in a multi-host NIC, in accordance with an embodiment of the invention.

### DETAILED DESCRIPTION

The following description is presented to enable any person skilled in the art to make and use the invention, and is provided in the context of particular applications of the invention and their requirements. Various modifications to the disclosed embodiments will be readily apparent to those skilled in the art and the general principles defined herein may be applied to other embodiments and applications without departing from the scope of the present invention. Thus, the present invention is not intended to be limited to the embodiments shown, but is to be accorded the widest scope consistent with the principles and features disclosed herein.

The program environment in which a present embodiment of the invention is executed illustratively incorporates a general-purpose computer or a special purpose device such as a hand-held computer. Details of such devices (e.g., processor, memory, data storage, display) may be omitted for the sake of clarity.

It should also be understood that the techniques of the present invention may be implemented using a variety of technologies. For example, the methods described herein may be implemented in software executing on a computer system, or implemented in hardware utilizing either a combination of microprocessors or other specially designed application specific integrated circuits, programmable logic devices, or various combinations thereof. In particular, the methods described herein may be implemented by a series of computer-executable instructions residing on a suitable computer-readable medium. Suitable computer-readable media may include volatile (e.g., RAM) and/or non-volatile (e.g., ROM, disk) memory, carrier waves and transmission media (e.g., copper wire, coaxial cable, fiber optic media). Exemplary carrier waves may take the form of electrical, electromagnetic or optical signals conveying digital data streams along a local network, a publicly accessible network such as the Internet or some other communication link.

An apparatus and method are provided for filtering communications received at a network interface device, such as a bridge, router, switch, NIC (Network Interface Card) or other network communication device, to identify communications addressed to one of multiple hosts served by the device.

In one embodiment of the invention, a network interface device is coupled to multiple networks, wherein one of the networks comprises hosts served by the device. In this embodiment, each host has an associated MAC (Medium Access Control) or other address, which may be assigned by the device. Each host MAC address has a portion common to all hosts served by the device. Illustratively, the common portion may comprise the first N bytes or N bits of the address, where N is less than 6 bytes or 48 bits. In one implementation of the invention, the common portion of the hosts MAC addresses encompasses the first 5 bytes; in another implementation, the first 36 bits.

However, the common portion need not be continuous. For example, the common portion of the hosts' MAC addresses may comprise the first 3 bytes plus the 5^{th} byte.

Besides the first, or common, portion, host addresses also include a second portion that is unique among all hosts served by the network interface device. Thus, if the common portion of each host MAC address comprises the first 5 bytes, then the 6^{th} byte, or some portion thereof, will be unique. As with the first address portion, the second portion need not be continuous. Illustratively, the first portion plus the second portion of a host MAC address may comprise the entire address, but the combination may comprise less than the full address in an alternative embodiment of the invention.

When a communication (e.g., packet, frame, cell) is received at the network interface device, the device compares a first portion of the destination address of the communication to the common portion of the MAC addresses of the device's hosts. If they match, the device uses a second portion of the destination address, which corresponds to the second portion of the hosts' MAC addresses, to lookup a communication connection to the host having that unique second portion. The communication may be forwarded to the correct host.

In an alternative embodiment of the invention, a network interface device filters communications based on addresses or identifiers at a level other than level two of the seven-layer network model. For example, a network interface device may filter communications based on IP (Internet Protocol) addresses that can be dissected into multiple portions as described above.

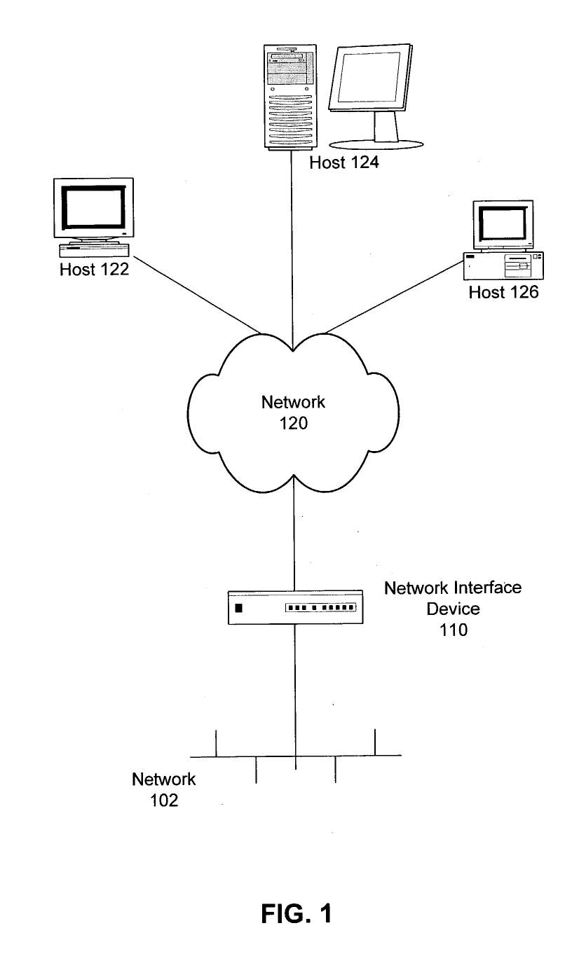

FIG. 1 depicts a network environment in which an embodiment of the invention may be implemented. In FIG. 1, network interface device 110 couples a first network, network 102, to a second network, network 120. Network 120 comprises multiple hosts, including hosts 122, 124, 126. Also, one or more hosts may be directly connected to device 110. A host in the environment of FIG. 1 may be a server having one or more blades.

In this embodiment of the invention, the networks may correspond to any protocols and topologies, now known or hereafter developed. Similarly, within a network, hosts may be interconnected via wired and/or wireless links, using any combination of protocols and equipment (e.g., switches, routers, repeaters).

In one embodiment of the invention, network addresses of the hosts in network 120 that are served by device 110 are consecutive. In particular, in this embodiment, each host address comprises a first portion, or prefix, comprising the first N bits or bytes of the address, and a second portion, or suffix, comprising the remaining bits or bytes. The first portion of each host address is identical, while the second portion is unique. In an alternative embodiment, the first and or second portion may comprise a non-contiguous portion of the address.

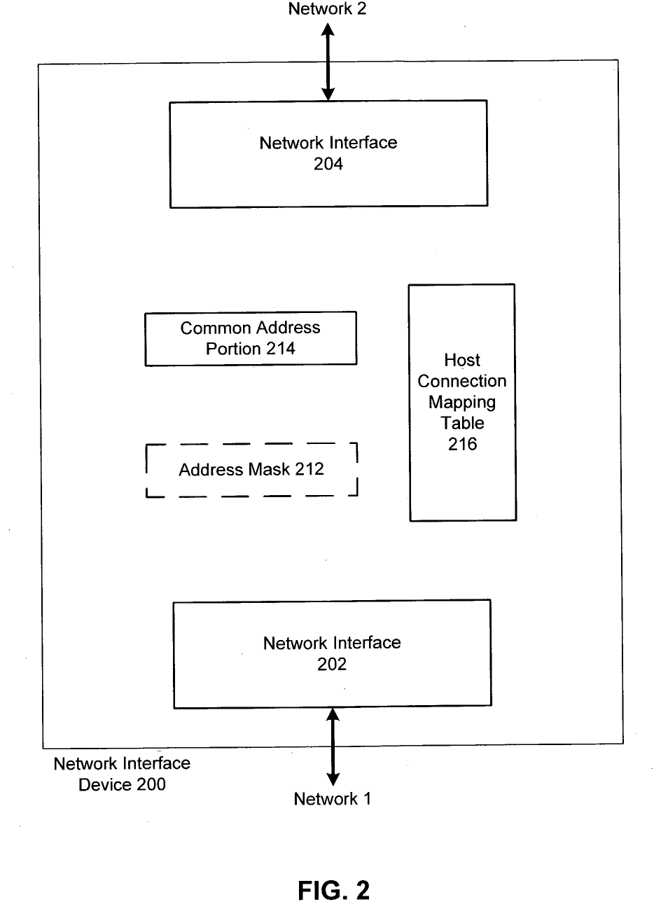

FIG. 2 depicts a network interface device (e.g., device 110 of FIG. 1) configured according to one embodiment of the invention. Network interface device 200 of FIG. 2 couples a first network (Network 1) to a second network (Network 2). Illustratively, network 1 is an Ethernet network, while network 2 is an InfiniBand network or fabric.

Device 200 comprises one or more network interface cards or components for interfacing with the networks. Thus, NIC 202 couples device 200 to network 1, while NIC 204 couples device 200 to network 2. In one alternative embodiment of the invention, device 200 comprises a single NIC configured to interface the device to both networks. In another alternative embodiment, device 200 comprises three or more NICs.

Network interface device 200 also includes address mask 212, common address portion 214 and host connection mapping table 216. Mask 212 indicates or identifies the common portion of the MAC addresses of hosts served by device 200. For example, a mask value of FF FF FF FF FF 00 may be applied to indicate that the first or common portion of the host addresses includes the first five bytes. A mask value of FF FF FF 80 FF 00 may signal that the common portion includes the first 28 bits plus the fifth byte. As described above, the common portion of hosts' MAC addresses may comprise any combination of bits and/or bytes, and may be manipulated in any fashion (e.g., shifted, rotated, reversed).

In one implementation of the illustrated embodiment of the invention, the portion of a MAC address not corresponding to mask 212 is used as the second portion of the address for uniquely identifying a host served by the network interface device (or a communication connection to that host). Thus, in the two examples above, the second portion would comprise the 6^{th} byte in the first case, and the combination of the second half of the 4^{th} byte plus the 6^{th} byte in the second case. In one alternative embodiment of the invention, device 200 may comprise a second mask for identifying the second portion of the address to be used for identifying a host or host connection.

Common address portion 214 of network interface device 200 stores the common portion of each host's MAC address, which corresponds to address mask 212. Thus, if the common portion of the host MAC addresses comprises the first four bytes, common address portion 214 may store a four byte value. If the common portion comprises some combination of 36 bits of a MAC address, then common address portion 214 may store those 36 bits.

The value of common address portion 214 may be stored as a consecutive string of bits or bytes, or may be stored in the pattern of mask 212, in which case the bits or bytes may be separated by nulls or may be extracted from common address portion 214 using mask 212.

In one embodiment of the invention, address mask 212 may be omitted, in which case a destination address of a communication received at device 200 from network 1 may be compared with common address portion 214 and some other means may be applied to indicate which bits or bytes of the common address portion the destination address must match in order for the communication to be forwarded to a host. For example, a second portion mask may be used to identify the bits/bytes of an address that do not correspond to the common portion. By default, all the remaining bits/bytes indicate the common portion.

Host connection mapping table 216 stores identifiers of the communication connections (e.g., queue pairs, virtual circuits) that network interface device 200 may use to forward a communication to a host. In the illustrated embodiment of the invention, the index into table 216 comprises a second portion of the destination address of a communication from network 1, which may include all or a portion of the destination address not corresponding to common address portion 214.

In one embodiment of the invention, table 216 is configured to store a connection identifier for each possible value of the second MAC address portion. For example, if the common portion of hosts' MAC addresses comprises the first five bytes, and the second portion comprises the remaining sixth byte, table 216 may be configured to store 256 connection identifiers.

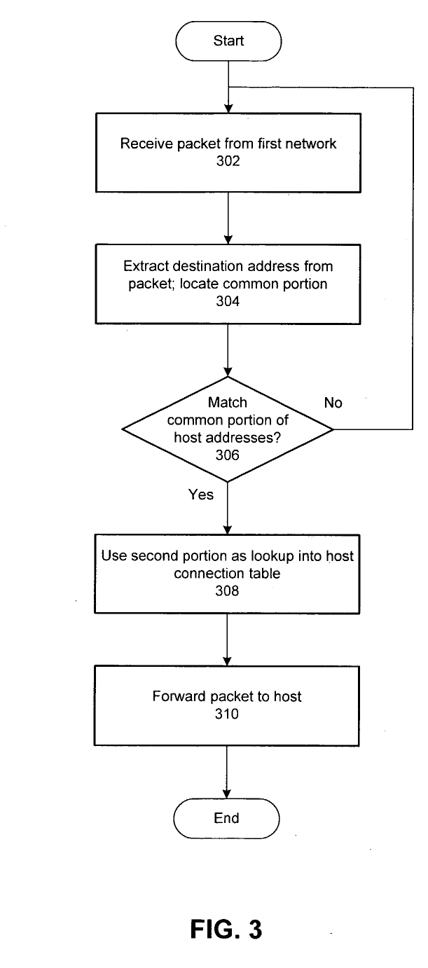

FIG. 3 is a flowchart demonstrating one method of using a multi-host network interface device (e.g., device 200 of FIG. 2) to process communications, according to one embodiment of the invention.

In state 302, a communication is received at the multi-host network interface device from a first network connection.

In state 304, a destination address or identifier of the communication is extracted. The common portion of the address, corresponding to the portion of a host's address that is identical to each host, is identified. The common portion may be located using a first mask or other means.

A second portion of the destination address may also be identified. The second portion may correspond to a second mask, or may, by default, include all bits or bytes of the destination address not corresponding to the first mask.

In state 306, the device determines whether the masked (or otherwise identified) portion of the destination address matches the common portion of the hosts' addresses. If they match, the illustrated method proceeds to state 308. Otherwise, the method returns to await the next communication.

In state 308, the second portion of the destination address uniquely identifies one of the multiple hosts. Therefore, the second portion is used as an index into a host communication connection table, to identify a connection (e.g., between the device and a host) corresponding to the host.

In state 310, the communication is forwarded, redirected or otherwise sent to the host. The method then ends.

The foregoing embodiments of the invention have been presented for purposes of illustration and description only. They are not intended to be exhaustive or to limit the invention to the forms disclosed. Accordingly, the scope of the invention is defined by the appended claims, not the preceding disclosure.

What is claimed is:

1. A method of directing an electronic communication to one of multiple hosts served by a network interface device, comprising:
receiving a communication at a network interface device;
comparing a first portion of a destination address of the communication to a first address portion common to addresses of multiple hosts coupled to the network interface device; and
forwarding the communication to a host identified by a second portion of the destination address, wherein the first portion of the destination address is distinct from the second portion of the destination address.

2. The method of claim 1, further comprising extracting the first portion of the destination address.

3. The method of claim 2, wherein said extracting comprises:
applying a mask configured according to the first address portion common the multiple hosts.

4. The method of claim 1, wherein said forwarding comprises:
using the second portion of the destination address as an index into a collection of communication connections coupling the network interface device to the multiple hosts.

5. The method of claim 4, wherein each of said communication connections comprises an InfiniBand queue pair.

6. The method of claim 1, further comprising:
extracting the second portion of the destination address;
wherein a concatenation of the first portion of the destination address and the second portion of the destination address matches the destination address.

7. The method of claim 1, wherein the network interface device comprises a network interface card.

8. The method of claim 1, wherein the network interface device couples a first network to a second network comprising the multiple hosts.

9. The method of claim 8, wherein the second network is an InfiniBand network.

10. A computer readable storage medium storing instructions that, when executed by a computer, cause the computer to perform a method of directing an electronic communication to one of multiple hosts served by a network interface device, the method comprising:
receiving a communication at a network interface device;
comparing a first portion of a destination address of the communication to a first address portion common to addresses of multiple hosts coupled to the network interface device; and
forwarding the communication to a host identified by a second portion of the destination address, wherein the first portion of the destination address is distinct from the second portion of the destination address.

11. A method of address filtering in a multi-host network interface, comprising:
receiving a packet at a network interface coupling multiple hosts to a first network, wherein each host is identifiable by an address comprising:
a first host address portion common to each of the multiple hosts; and
a second host address portion unique to the host; extracting a destination address from the packet; applying a mask to identify a first portion of the destination address; comparing the first portion of the destination address to the first host address portion;
identifying a second portion of the destination address; and
identifying a communication connection between the network interface and a host having a second host address portion that matches the second portion of the destination address.

12. The method of claim 11, further comprising:
configuring the mask to identify each bit of a host address that is part of the first host address portion.

13. The method of claim 11, wherein said identifying a second portion of the destination address comprises:
retrieving every bit of the destination address not corresponding to said mask.

14. The method of claim 11, wherein said identifying a communication connection comprises:
using the second portion of the destination address as an index into a table of communication connections between the network interface and the multiple hosts.

15. The method of claim 11, wherein the first host address portion comprises a consecutive sequence of bits starting with the first address bit.

16. The method of claim 11, wherein the first host address portion comprises a nonconsecutive sequence of address bits.

17. The method of claim 11, wherein the second host address portion comprises a consecutive sequence of bits ending with a final bit of the address.

18. The method of claim 11, wherein the second host address portion comprises a nonconsecutive sequence of address bits.

19. The method of claim 11, further comprising:
assigning consecutive addresses to the multiple hosts.

20. The method of claim 11, wherein the second portion of the destination address is different from the first portion of the destination address.

21. A computer readable storage medium storing instructions that, when executed by a computer, cause the computer to perform a method of address filtering in a multi-host network interface, the method comprising:
receiving a packet at a network interface coupling multiple hosts to a first network, wherein each host is identifiable by an address comprising:
a first host address portion common to each of the multiple hosts; and
a second host address portion unique to the host;
extracting a destination address from the packet;
applying a mask to identify a first portion of the destination address; comparing the first portion of the destination address to the first host address portion;
identifying a second portion of the destination address; and
identifying a communication connection between the network interface and a host having a second host address portion that matches the second portion of the destination address.

22. An apparatus for interfacing a network with multiple host computing devices, comprising:
a first network port configured to receive a communication from a first network;
a second network port configured to forward the communication to one of multiple hosts, including a first host;
a memory configured to store connection identifiers identifying communication connections between the apparatus and the multiple hosts; and
a first partial host address common to the multiple hosts.

23. The apparatus of claim 22, wherein:
each of the multiple hosts has an associated address; and
each said address comprises:
said first partial host address; and
a second partial host address unique to the associated host.

24. The apparatus of claim 23, wherein said memory is indexed by said second partial host addresses of the multiple hosts.

25. The apparatus of claim 23, further comprising a mask corresponding to said first partial host address.

26. The apparatus of claim 23, wherein said first partial host address comprises a consecutive series of address bits starting with the first bit of the host address.

27. The apparatus of claim 23, wherein said first partial host address comprises a nonconsecutive set of bits of the host address.

28. The apparatus of claim 23, wherein said second partial host address comprises a consecutive series of address bits ending with the final bit of the host address.

29. The apparatus of claim 23, wherein said second partial host address comprises a nonconsecutive set of bits of the host address.

30. The apparatus of claim 22, further comprising:
a comparator configured to compare a first portion of a destination address of the communication to said first partial host address.

31. The apparatus of claim 22, further comprising:
an address mask configured to identify a first portion of a destination address of the communication corresponding to said first partial host address.

32. The apparatus of claim 22, wherein the second network is an InfiniBand network and said communication connections are InfiniBand queue pairs.

33. The apparatus of claim 32, wherein said second network port comprises a target channel adapter.

34. The apparatus of claim 32, wherein the first network is an Ethernet network.

35. The apparatus of claim 22, wherein said addresses-of the multiple hosts are MAC (Medium Access Control) addresses.
